(19) United States
(12) Patent Application Publication
(10) Pub. No.: US 2007/0154660 A1
(43) Pub. Date: Jul. 5, 2007

(54) Ornamental device for providing moving visual effects

(76) Inventors: Larry J. Schultz, Walker, MN (US); John L. Bezek, Walker, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/356,528

(22) Filed: Feb. 17, 2006

Related U.S. Application Data
(60) Provisional application No. 60/755,715, filed on Dec. 30, 2005.

(51) Int. Cl. G09F 17/00

(52) U.S. Cl. 428/7

(57) ABSTRACT

An ornamental device is disclosed, including a substantially vertical axis, and a plurality of substantially concentric ring-shaped members. The plurality of ring-shaped members may include a first group of rings having a scalloped outline, at least one ring having a smooth outline, and a second group of rings having a scalloped outline. The plurality of substantially concentric ring-shaped members form vertical planes that are angularly offset from one another and that intersect one another substantially along the vertical axis of the device, giving the device a three-dimensional shape. The device may be adapted to rotate about the vertical axis to present interesting, moving visual effects to an observer.

### RELATED APPLICATIONS

This application claims priority from provisional application Ser. No. 60/755,715, filed Dec. 30, 2005, the entire disclosure of which is hereby incorporated by reference.

### FIELD

This disclosure relates generally to ornamental devices, and more particularly, to movable ornamental devices which present unusual and interesting visual effects to an observer when the device is placed in motion. The disclosure also relates to a method of making such a device.

### BACKGROUND

A variety of decorative ornaments have been developed throughout the years for use in areas such as back or front yards, patios, balconies, and the like. These devices include, for example, wind chimes which have a number of sound producing elements, and which are sometimes shaped as ornaments. These devices are typically suspended on strings and may produce distinct musical notes or chimes when the elements strike one another while being tossed about by a gust of wind. Other devices include weathervanes which can come in a number of decorative designs to complement a particular setting. Still other such devices include windsocks which catch the wind and deploy to display a colorful arrangement that can create an interesting visual effect. Pinwheels are an example of devices which can adorn a garden or yard area to provide a whirling visual effect when wind sets the pinwheel in motion. Spinning objects may have turbine-like, curved vanes, which can also create a colorful spinning effect when rotated by the wind. The visual effects created by these devices can be interesting, and may be useful as attention-getting devices.

Consumers continue to search for new and unusual ornaments which can be placed in an open area, or even indoors, for decorative purposes, as signage to attract the attention of potential customers, or to simply provide a unique visual effect to an observer. Therefore, there is an ongoing need for new ornamental devices that can be displayed to provide an interesting, attention-getting visual effect that enhances the beauty of a setting, provides an ornament for a particular holiday or time of the season, or attracts potential customers to a place of business.

### SUMMARY OF THE INVENTION

In certain embodiments of the invention, an ornamental device includes a plurality of generally annular (i.e., ring-shaped) members, including inner members and outer members, each member having a substantially planar surface. The substantially planar surfaces of the plurality of members are angularly displaced from one another about an axis of rotation of the device, and are further adapted to intersect substantially along the axis of rotation of the device. An inner visual effect and an outer visual effect are formed by the movement of the inner and outer members, respectively, upon rotation of the ornamental device about the axis of rotation.

In certain other embodiments of the invention, an ornamental device has a substantially vertical axis, and a plurality of substantially concentric rings, the plurality of rings comprising a first group of rings having a scalloped outline, at least one ring having a smooth outline, and a second group of rings having a scalloped outline. The first group of rings have radii greater than that of the at least one smooth ring, and the second group of rings have radii less than that of the at least one smooth ring. The plurality of substantially concentric rings defines a plurality of substantially vertical planes that intersect one another substantially along the vertical axis of the device, the planes being angularly offset from one another to give the device a three-dimensional shape. An ornamental device according to certain embodiments of the invention is adapted to rotate about the vertical axis, such rotation causing multiple moving visual effects to be formed by the movement of the first and second groups of scalloped rings.

In another embodiment of the invention, a method of making an ornamental device that produces multiple moving visual effects includes cutting a flat sheet of material into a scalloped outline shape, making a plurality of cuts in the material to form both smooth and scalloped rings, the cuts terminating at an axis of symmetry of the scalloped outline shape, and bending the rings near the axis of symmetry to give the device a three-dimensional contour. Bending the plurality of rings may be performed such that the rings become angularly displaced from one another about an axis of rotation of the device, and are further adapted to intersect substantially along the axis of rotation of the device.

These and other features, advantages and objects of the present invention will be further understood and appreciated by those skilled in the art by reference to the following specification, drawings and claims.

### DESCRIPTION OF THE DRAWINGS

FIG. 1 is a simplified, two-dimensional front plan view of an ornamental device in accordance with an embodiment of the invention;

FIG. 2 is a top plan view of the ornamental device of FIG. 1 in an expanded three-dimensional configuration;

FIG. 3 is an enlarged front view -of a portion of an ornamental device in accordance with an embodiment of the invention;

FIG. 4 is a front perspective view of an ornamental device in accordance with an embodiment of the invention;

FIG. 5 is a two-dimensional front view of an ornamental device according to embodiments of the invention;

FIG. 6 is a top plan view of the ornamental device of FIG. 5 in an expanded three-dimensional configuration; and

FIG. 7 is a top plan view of the ornamental device of FIG. 5 in an alternate three-dimensional configuration.

### DETAILED DESCRIPTION

The following detailed description should be read with reference to the drawings, in which like elements in different drawings are numbered identically. The drawings depict selected embodiments and are not intended to limit the scope of the invention. It will be understood that embodiments shown in the drawings and described below are merely for illustrative purposes, and are not intended to limit the scope of the invention as defined in the claims.

A plurality of moving light or image patterns may be formed when a device in accordance with certain embodiments of the invention rotates about a substantially vertical axis by the repeated presentation (to an observer) of successively smaller (and/or larger) generally planar, generally vertical surfaces. Each generally planar surface may form a ring or annulus (or other similar “loop” shape). Two or more moving light or image patterns may be observed upon rotation of the device about a substantially vertical axis. The device may be formed of a first series of generally annular planar surfaces (e.g., rings or ring-shaped patterns) that present successively smaller (or larger) shapes to an observer upon rotation, and a second series of generally annular planar surfaces that present successively larger (or smaller) shapes to an observer upon rotation.

The presentation of a series of successively smaller shapes may tend to create a “collapsing” moving light effect or image pattern, while the presentation of a series of successively larger shapes tends to create an “exploding” moving light effect or image pattern. As the direction of rotation reverses, the effect of each series of planar surfaces reverses (i.e., a series that presented successively larger shapes upon rotation in a first direction now presents successively smaller shapes). The simultaneous presentation of two or more moving light or image patterns may present an effect that may be described as either a “diverging” effect (i.e., two moving images that repeatedly diverge from each other), or a “converging” effect (i.e., two moving images that repeatedly converge towards each other), depending on whether the device is rotating clockwise or counter-clockwise. More than two moving patterns may be created according to certain embodiments of the invention by adding additional series of planar surfaces arranged according to further embodiments of the invention. The two or more moving light or image patterns need not converge or diverge, and instead may move together in the same general direction (e.g., inward or outward).

An ornamental device according to certain embodiments of the invention may have a first series and a second series of generally planar, generally concentric annular members (e.g., rings or generally ring-shaped patterns), the largest member of one series being smaller than the smallest member of the other series. It should be noted that the term “generally concentric” may encompass annular members that have their central portions in roughly the same area, and may also encompass annular members that fit within (or around) adjacent annular members; a common geometric center is not required. In some embodiments, the members may have a similar shape, which may be substantially symmetric about an axis. The axis of symmetry may be a generally vertical axis in certain embodiments of the invention. The members of a given series may be angularly spaced from each other about the axis of symmetry such that, when viewed from a point on the axis of symmetry, the angular spacing of successively-sized (i.e., successively smaller or successively larger) members moves in a clockwise (or counter-clockwise) direction around the axis of symmetry. In some embodiments of the invention, the angular spacing of an inner series of members moves in a direction opposite the angular spacing of an outer series of members.

In certain embodiments of the invention, an ornamental device may be formed from a substantially flat sheet of material by cutting the material to form two or more series of generally annular (e.g., generally ring-shaped or looped) members. Any suitable material may be used to form an ornamental device according to certain embodiments of the invention. Materials that may be used include generally flat materials, such as flat stock steel, stainless steel and/or other metals, plastics, or other suitable types of flat materials. In certain preferred embodiments, 16 to 22 gauge metal may be used as the flat sheet material from which to form the device. However, one of ordinary skill in the art may choose other suitable materials based on considerations of cost, durability, ease of manufacture, etc., without departing from the scope of the invention as claimed.

In certain embodiments, including embodiments of the invention that include cutting flat or sheet materials, techniques for cutting the material may include laser cutting techniques, plasma cutting techniques, water-jet cutting techniques, stamping, injection molding, and/or pin routing (depending on the material being used) to form the annular members. In some embodiments, the cuts do not complete a full 360 degree path around the annular members. Instead, certain embodiments include cuts that form substantially semi-circular paths, leaving an area of material near the axis of symmetry that is substantially un-cut. Thus, in some embodiments, the annular members comprise pairs of semi-circular members on either side of an axis of symmetry formed by the above-mentioned cutting of material.

In some embodiments of the invention, the ornamental device is formed into a three-dimensional shape after cutting the material by bending the annular members (or the semi-circular members that form the annular members) from a reference plane (i.e., the plane of the original flat sheet of material in some embodiments, or the plane of the outer-most annular member in certain other embodiments) about the axis of symmetry of the device to form a new plane. In some embodiments, the bending of annular members about the axis of symmetry forms a plurality of substantially vertical planes that intersect each other near the axis of symmetry. The bending of material may occur near the substantially un-cut portion of material near the axis of symmetry.

The bending of annular members may provide angular spacing between adjacent annular members. In certain embodiments, angular spacing between adjacent members moves in a certain direction when viewed from above (or below) the device. For example, a first series of annular members may be angularly spaced from a reference plane such that successively members in the series form progressively larger angles with the reference plane moving in a counter-clockwise direction when viewed from above. In certain embodiments, a second series of annular members within the same device may be angularly spaced from each other moving in the opposite direction (i.e., clockwise) when viewed from above. Of course, one of ordinary skill in the art would recognize that the directions could be reversed, or that the directions could be the same as each other, or that there could be more than two series of annular members. Other possible combinations may be achieved by one of ordinary skill with the benefit of these teachings, and would be considered to fall within the scope of the claimed invention.

In certain further embodiments of the invention, “dividing” members may be included to provide separation between the two or more series of annular members. The dividing members may be of a different shape than those of the two or more series of annular members, or may be a substantially smooth or circular shape, or may be of any other suitable shape to separate the different series of members.

In certain other further embodiments of the invention, a “central figure ” or “figurine” may be included to provide an additional interesting visual effect or novelty. For example, a central figure may be formed from the same flat sheet that is used to form the plurality of annular members, and may be cut to create an endless variety of shapes (e.g., stars, moons, animals, smiley faces, arbitrary shapes, etc.). Alternately, a central figurine might be formed as a three-dimensional object disposed in a central portion of the device (e.g., within a space created by the innermost annular member) according to certain embodiments of the invention. A central figure or figurine is not necessary for producing the collapsing, exploding, diverging, converging, and other moving visual effects in accordance with embodiments of the invention. However, the use of a central figure or figurine in certain embodiments of the invention may add an additional interesting visual aspect that may further enhance the overall visual effect(s) produced by such an ornamental device.

In still further embodiments of the invention, the annular members may have a shape or contoured outline or pattern. For example, certain embodiments of the invention may have annular members with patterns, shapes, and/or outlines including, but not limited to wavy, scalloped, circular, semi-circular, diamond, and elliptical shapes. Other shapes and patterns could be adapted for use with certain embodiments of the invention without departing from the scope of the invention as claimed. In some embodiments, a first and second series of annular members may have a similar wavy or scalloped shape. In other embodiments, two or more series of annular members may have different shapes. A wavy shape may, for example, comprise a smoothly oscillating (e.g., sinusoidal) outline for the outer and/or inner periphery of an annular member. A scalloped shape may, for example, comprise a series of crescent-shaped portions around the periphery of an annular member. The shape or contoured outline of the annular members is not necessary to produce the collapsing, exploding, diverging and/or converging visual effect(s) according to various embodiments of the invention. However, the shape, contoured outline, or patterns of the annular members may further enhance the overall visual effect(s) produced by such an ornamental device.

To an observer of the device, a moving light pattern may be created by each series of annular members, which appears to repeatedly move inwardly (i.e., “collapses”) toward the center of the object as the device rotates about a vertical axis in one direction; the moving light pattern appears to repeatedly expand outwardly (i.e., “explodes”) if it rotates in the opposite direction. The appearance of a moving light pattern is caused by presenting a succession of substantially vertical planar surfaces to an observer, each successive planar surface having a progressively larger or smaller size as the device rotates about a substantially vertical axis. The appearance of the moving light pattern may be enhanced by improving the ability of the planar surfaces to reflect light. For example, providing a smooth, shiny surface (e.g., by machining and/or polishing) may enhance the ability of the surface to reflect light. In some embodiments, planar surfaces of the device may be adapted to reflect light by applying a sanding and/or finishing process to a planar surface in a direction that is generally perpendicular to the grain of the material, or in some cases, generally perpendicular to the vertical axis of the device. In certain embodiments, a reflective coating or a reflective paint may be additionally or alternately applied to the planar surfaces to improve light reflectivity and thereby enhance the appearance of the moving light patterns.

### EMBODIMENT 1

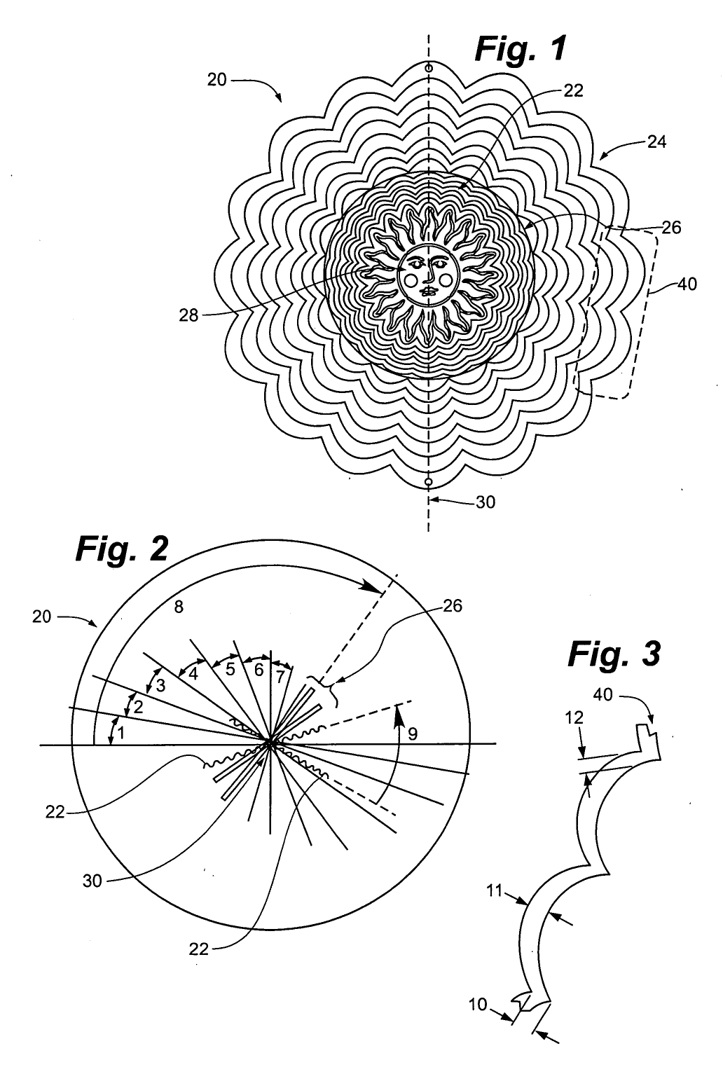

An ornamental device in accordance with certain embodiments of the invention is shown in FIGS. 1-4. FIG. 1 shows a front view of device 20, which includes a plurality of generally annular (i.e., generally ring-shaped) members, including a plurality of inner members 22 and a plurality of outer members 24. With reference to FIG. 1, the radii of outer members 24 is generally greater than that of the inner members 22. In certain embodiments, the plurality of annular members may be generally concentric, although not necessarily co-planar. As shown in FIG. 1, inner and outer members 22, 24 may have a wavy or scalloped or other shaped outline pattern. In certain embodiments, both the outer and inner portions of a given annular member 22, 24 may be wavy or scalloped; in other embodiments, either the outer or inner portion may be wavy or scalloped, the opposite portion being smooth. The scalloped and smooth patterns will be described in more detail below. FIG. 1 also shows vertical axis 30, which may serve as an axis of symmetry for each of the annular members, as well as an axis of rotation for the ornamental device 20.

With continued reference to FIG. 1, outer members 24 may include any number of generally annular members. In certain preferred embodiments of the invention, the number of outer members 24 may be three or more, and in more preferred embodiments of the invention, the number of outer members may range from three to 20 members. In some preferred embodiments, the number of outer members ranges from six to ten. Similarly, the number of inner members 22 may be any suitable number. In certain embodiments of the invention, the number of inner members may range from 2 to 12 members, and in some preferred embodiments, the number of inner members ranges from 3-10 members.

In certain embodiments of the invention, ornamental device 20 may have one or more generally smooth annular members 26 disposed radially between the plurality of inner members 22 and outer members 24. The one or more generally smooth annular members 26 may have a substantially oval or substantially circular shape on both the outer and inner edges thereof. In a preferred embodiment, there may be two smooth annular members 26 disposed radially between the plurality of inner members 22 and outer members 24.

As shown in FIG. 1, certain embodiments may optionally also include an arbitrary ornamental figurine 28 disposed near the center of ornamental device 20. For example, the center figurine 28 may be located radially within the innermost inner member 22 in certain embodiments of the invention. Figurine 28 may be of any suitable shape or design desired in accordance with certain embodiments of the invention. In certain embodiments, figurine 28 may be made of a flat sheet of material, and may be formed from a sheet of material that is also used to form the plurality of generally annular members. In other embodiments, figurine 28 may alternately have a three-dimensional shape.

Each of the annular members of device 20 has a substantially planar surface, i.e., a relatively flat surface, as observed in FIG. 1. The plurality of members 22, 24, 26 may also have a thickness that is relatively small in comparison to the area presented by the substantially planar surface of each member.

FIG. 2 is a top view of ornamental device 20. As shown, device 20 may obtain an overall three-dimensional contour or profile due to the angular displacement of the annular members 22, 24, 26. For example, outer members 24 are angularly displaced from one another by the angles indicated at reference numerals 1 through 7 in FIG. 2. For example, a total of eight outer members 24 may be angularly displaced from one another such that the total angular displacement of the outer members 24 spans an arc shown by reference numeral 8, which may be less than or greater than 90 degrees, as illustrated in FIG. 2. The angular displacement between outer members 24 may be greater than about 5 degrees in certain embodiments, and may more preferably be between about 5 and 30 degrees. In some preferred embodiments, the angular displacement between outer members 24 may range from about 10 to 15 degrees. Further, the angular displacement may vary between members of a series (e.g., angles 1 through 7 may be different angles). Note that the aforementioned angles describe only one half of the device 20; a mirror image of the annular members forms a similar pattern of angular displacement located approximately 180 degrees around vertical axis 30, as shown in FIG. 2. FIG. 2 also illustrates that each of the annular members intersects with the other annular members at approximately the vertical axis 30.

The arc illustrated by reference numeral 8 also has a directional component, indicating that the angular displacement of progressively smaller outer members 24 moves in a clockwise direction in the embodiment illustrated in FIG. 2. The bending of the outer members 24 may be said to move in clockwise direction, for example. Of course, the direction of bending could be defined differently, and the direction itself could be reversed, as would be apparent to one of ordinary skill in the art.

FIG. 2 also shows the angular displacement of inner members 22. For example, two inner members 22 are shown angularly displaced by an angle indicated by reference numeral 9. In certain embodiments of the invention, the angular displacement between neighboring inner members 22 may be different from the angular displacement between the outer members 24.

The angular displacement between inner members 22 may be greater than about 20 degrees in certain embodiments, and may more preferably be between about 25 and 90 degrees. In some preferred embodiments, the angular displacement between inner members 22 may range from about 30 to 60 degrees.

Note that the angle illustrated by reference numeral 9 has a directional component, indicating that the direction of bending the inner members 22 moves in a counter-clockwise direction in the embodiment illustrated in FIG. 2. In certain embodiments of the invention, having two series of members that bend in opposite directions (e.g., directions 8 and 9 in FIG. 2) may cause the ornamental device 20 to create an interesting visual effect that may comprise two moving light or image patterns which appear to repeatedly move toward or away from each other, depending on the direction of rotation of device 20.

FIG. 3 shows the enlarged portion 40 identified in FIG. 1. Portion 40, as shown in FIG. 3, identifies certain features of a scalloped shaped which may be found in the inner and outer members 22, 24, according to certain embodiments of the invention. For example, dimension 10, the radial extent of the end of each scalloped portion may bear a relationship to dimension 11, which defines the radial extent of the scalloped portion at its widest point. For example, dimension 10 and dimension 11 may be approximately equal, or dimension 10 may be somewhat smaller or larger than dimension 11, for example. Dimension 12, also shown in FIG. 3, identifies a relatively narrow aspect of the scalloped portion of an annular member defined by the radial extent (using the center of the scalloped portion as the reference, rather than the center of the ornamental device 20). The narrow aspect shown as dimension 12 may typically be located near the end of a scalloped portion. In some embodiments of the invention, dimension 12 may be smaller than dimensions 10 and 11 to obtain the overall scalloped appearance. The number of scalloped portions that a given annular member has is somewhat arbitrary and may be varied to obtain a different visual effect. For example, the number of scalloped portions in a given annular member may be from 10 to 30, and more preferably between about 12 and 18. In one embodiment, the number of scalloped portions in the outer members 24 may be different from the number of scalloped portions in the inner members 22. In one particularly preferred embodiment, the number of scalloped portions in the outer members is 16 and the number of scalloped portions in the inner members is 20.

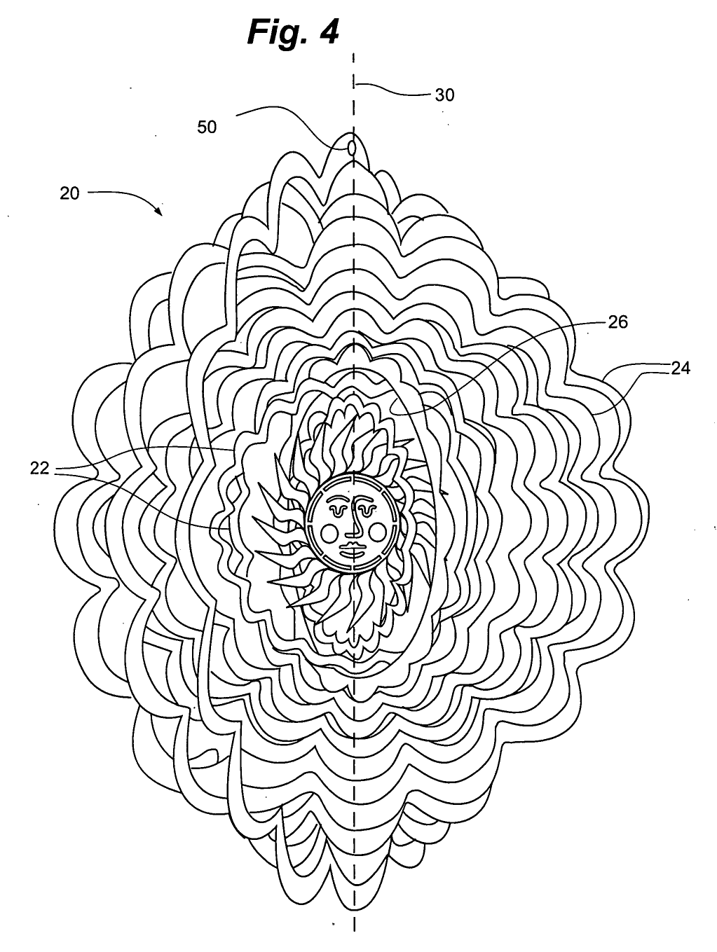

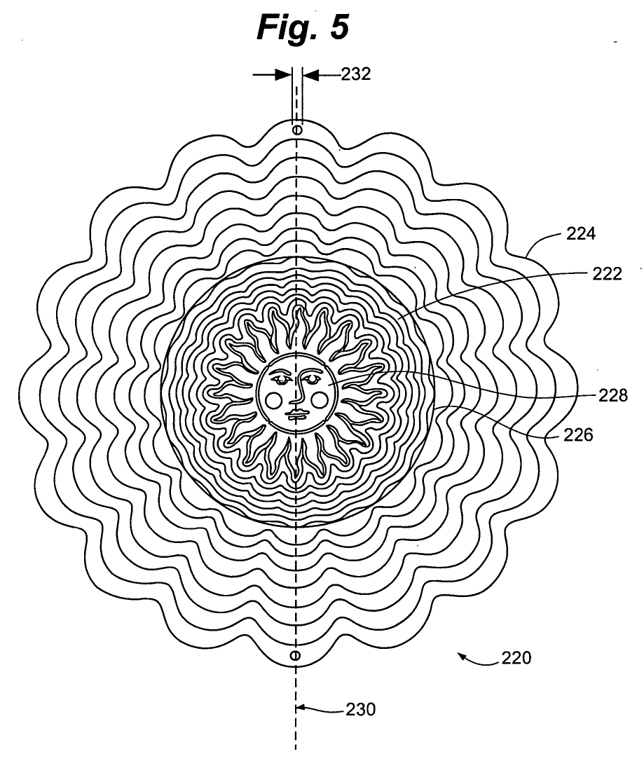

FIG. 4 is a front perspective view of device 20 in a stationary aspect. As shown in FIG. 4, an aperture 50 may be formed near the top-most portion of the outer-most outer member 24. The aperture 50 may be in alignment with vertical axis 30, and may further be adapted to mount or suspend device 20 in a manner that allows for rotation of device 20 about the vertical axis 30. Of course, other means of suspending device 20 to allow for rotation about the vertical axis 30 may be devised by one of ordinary skill with the benefit of these teachings. For example, aperture 50 may be formed in any portion of device 20 to provide rotatable suspension. Similarly, bearings and swivel devices known in the art may be coupled to device 20 to provide rotatable suspension. Such minor modifications are contemplated and are deemed to fall within the scope of the invention as claimed.

Upon rotation of device 20 about vertical axis 30, a visual image or a visual effect is produced by the movement of the inner and outer members 22, 24. For example, when device 20 is caused to rotate in one direction, an observer will see a generally annular image that appears to repeatedly move from the outer-most outer member 24 toward the inner-most outer member 24 to create a collapsing image effect. Concurrently, the movement of the inner members 22 creates a generally annular visual image or effect that appears to expand outwardly from the inner-most inner member 22 to the outer-most inner member 22 to create an exploding visual image or effect. Conversely, when device 20 is caused to spin in the opposite direction, the visual images or effects created are simply reversed.

As can be seen in FIG. 1 and 4, device 20 may also include an arbitrary ornamental center figurine 28. Figurine 28, as explained above, may be of any suitable design or pattern, and may be chosen based on purely aesthetic reasons. The choice of ornamental center figurine 28 may be adopted or changed by one of ordinary skill in the art without departing from the scope of the claimed invention.

A method of making an ornamental device in accordance with certain embodiments of the invention is described next. Device 20 is preferably made by cutting and bending a flat sheet of material. As shown in FIGS. 1 and 4, device 20 is fabricated from a sheet of material cut into a shape (e.g., generally round, or generally circular, or other shapes that are generally symmetric about a vertical axis 30). In some embodiments, the device 20 may be cut to further include a shaped or patterned outline or outer edge. Such a patterned outline or outer edge may include, but is not limited to, the following types of shapes: wavy, scalloped, circular, semi-circular, diamond, and elliptical shapes, or combinations of such shapes. Other shapes and patterns could be adapted for use with certain embodiments of the invention without departing from the scope of the invention as claimed. A plurality of cuts may be made in the sheet, the cuts typically extending approximately 180 degrees on either side of a vertical axis 30. The cuts may be made in pairs, each pair of cuts generally following the shape of the device with the ends of the cuts separated from each other by sheet material near the vertical axis 30. The plurality of cuts thereby form a plurality of generally annular members 22, 24, 26 connected by a portion or portions of material that extend substantially along the vertical axis 30 of device 20. An arbitrary ornamental center FIG. 28 may be cut into the sheet of material, as shown in FIGS. 1 and 4. Device 20 is next given a three-dimensional profile or contour by bending the generally annular members 22, 24, 26 in a direction generally orthogonal to the vertical axis 30 so that each annular member defines a generally vertical plane which is angularly displaced about the vertical axis 30 from adjacent annular members.

### EMBODIMENT 2

An ornamental device in accordance with certain embodiments of the invention is described with reference to FIGS. 5-7. FIG. 5 shows a front view of device 220, which includes a plurality of generally annular (i.e., generally ring-shaped) members, including a plurality of inner members 222 and a plurality of outer members 224. With reference to FIG. 5, the radii of outer members 224 is generally greater than that of the inner members 222. In certain embodiments, the plurality of annular members may be generally concentric, although not necessarily co-planar. As shown in FIG. 5, inner and outer members 222, 224 may have a wavy or scalloped or other shaped outline pattern. In certain embodiments, both the outer and inner portions of a given annular member 222, 224 may be wavy or scalloped; in other embodiments, either the outer or inner portion may be wavy or scalloped, the opposite portion being smooth. FIG. 5 also shows vertical axis 230, which may serve as an axis of symmetry for each of the annular members, as well as an axis of rotation for the ornamental device 220.

In certain embodiments of the invention, ornamental device 220 may optionally have one or more generally smooth annular members 226 disposed radially between the plurality of inner members 222 and outer members 224. The one or more generally smooth annular members 226 may have a substantially oval or substantially circular shape on both the outer and inner edges thereof. In a preferred embodiment, there may be two smooth annular members 226 disposed radially between the plurality of inner members 222 and outer members 224.

Device 220 in FIG. 5 may be preferably made by cutting and bending a flat sheet of material. As shown, device 220 may be fabricated from a sheet of material cut into a shape (e.g., generally round, or generally circular, or other shapes that are generally symmetric about a vertical axis 230), having a wavy or scalloped outer edge. A plurality of cuts may be made in the sheet, the cuts typically extending approximately 180 degrees on either side of vertical axis 230. The cuts may be made in pairs, each pair of cuts generally following the shape of the device with the ends of the cuts separated from each other by sheet material near the vertical axis 230. The amount of separation between the ends of the cuts may be substantially as indicated at 232, or may be varied between pairs of cuts as deemed appropriate. The plurality of cuts thereby form a plurality of generally annular members 222, 224, 226 connected by a portion or portions of material that extend substantially along the vertical axis 230 of device 220. An arbitrary ornamental center FIG. 228 may be cut into the sheet of material, as shown in FIG. 5. In certain embodiments, FIG. 228 may be made of a flat sheet of material, and may be formed from a sheet of material that is also used to form the plurality of generally annular members. In other embodiments, FIG. 228 may alternately have a three-dimensional shape, and may be formed from a separate piece of material and operatively coupled to the annular members.

Each of the annular members of device 220 has a substantially planar surface, i.e., a relatively flat surface, as observed in FIG. 5. The plurality of members 222, 224, 226 may also have a thickness that is relatively small in comparison to the area presented by the substantially planar surface of each member. Device 220 obtains a three-dimensional profile or contour by bending the generally annular members 222, 224, 226 in a direction generally orthogonal to the vertical axis 230 so that each annular member defines a generally vertical plane which is angularly displaced about the-vertical axis 230 from adjacent annular members.

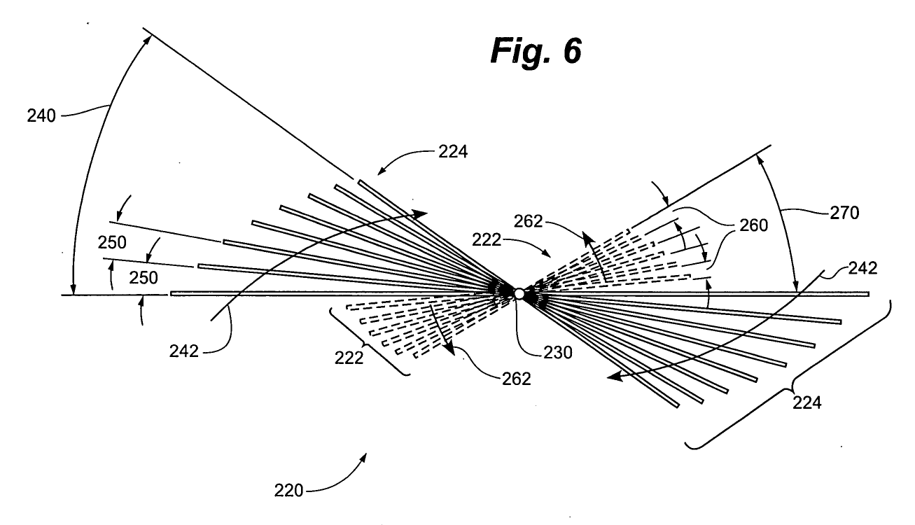

FIG. 6 is a top view of ornamental device 220. As shown, device 220 may obtain an overall three-dimensional contour or profile due to the angular displacement of the annular members. For example, outer members 224 are angularly displaced from one another as shown in FIG. 6. For example, a total of eight outer members 224 are shown in the embodiment of FIG. 6 angularly displaced from one another such that the angular displacement 240 of the outer members 224 spans an arc in the direction of progressively smaller outer members 224 which moves in a clockwise direction 242 about axis 230. The angular displacement 240 may range from about 25 to 60 degrees, as shown in FIG. 6, according to certain embodiment of the invention. The angular displacement 250 between adjacent outer members 224 may range from about 2 to 12 degrees in certain embodiments, and may more preferably range from about 3.5 to 8.6 degrees in certain embodiments. Note that the aforementioned angles describe only one half of the device 220; a mirror image of the annular members forms a similar pattern of angular displacement located approximately 180 degrees around vertical axis 230, as shown in FIG. 6. FIG. 6 also illustrates that each of the annular members intersects with the other annular members at approximately the vertical axis 230.

The angular displacement of progressively smaller outer members 224 moves in a clockwise direction 242 (when viewed from the top of device 220) in the embodiment illustrated in FIG. 6.

The bending of the outer members 224 may be said to move in clockwise direction, for example.

Of course, the direction of bending could be defined differently, and the direction itself could be reversed, as would be apparent to one of ordinary skill in the art.

FIG. 6 also shows the angular displacement of inner members 222. For example, a total of six inner members 222 are shown in the embodiment of FIG. 6 angularly displaced from one another such that the angular displacement 270 of the inner members 222 spans an arc in the direction of progressively smaller inner members 222 which moves in a counter-clockwise direction 262 about axis 230. The angular displacement 270 may range from about 25 to 60 degrees, as shown in FIG. 6, according to certain embodiment of the invention. The angular displacement 260 between adjacent inner members 222 may range from about 2 to 12 degrees in certain embodiments, and may more preferably range from about 3.5 to 8.6 degrees in certain embodiments. Note that the aforementioned angles describe only one half of the device 220; a mirror image of the annular members forms a similar pattern of angular displacement located approximately 180 degrees around vertical axis 230, as shown in FIG. 6. FIG. 6 also illustrates that each of the annular members intersects with the other annular members at approximately the vertical axis 230.

In certain embodiments of the invention, having two series of members (e.g., inner series and outer series of members 222, 224) that bend in opposite directions (e.g., directions 242 and 262 in FIG. 6) may cause the ornamental device 220 to create an interesting visual effect that may comprise two moving light or image patterns which appear to repeatedly move toward or away from each other, depending on the direction of rotation of device 220 about axis 230.

Upon rotation of device 220 about vertical axis 230, a visual image or a visual effect is produced by the movement of the inner and outer members 222, 224. For example, when device 220 is caused to rotate in one direction, an observer will see a generally annular image that appears to repeatedly move from the outer-most outer member 224 toward the inner-most outer member 224 to create a collapsing image effect. Concurrently, the movement of the inner members 222 creates a generally annular visual image or effect that appears to expand outwardly from the inner-most inner member 222 to the outer-most inner member 222 to create an exploding visual image or effect. Conversely, when device 220 is caused to spin in the opposite direction, the visual images or effects created are reversed.

In the embodiment shown in FIG. 6, the angular displacement 240 of the outer members 224 is distinct from the angular displacement 270 of the inner members 222. In such an embodiment, there may be no overlap between inner and outer members 222, 224. However, this is not a required aspect of the invention. In certain other embodiments, various amounts of overlap, or complete overlap of the inner and outer members 222 and 224, may be desired to create a slightly different visual effect, while still falling within the scope of the invention as claimed.

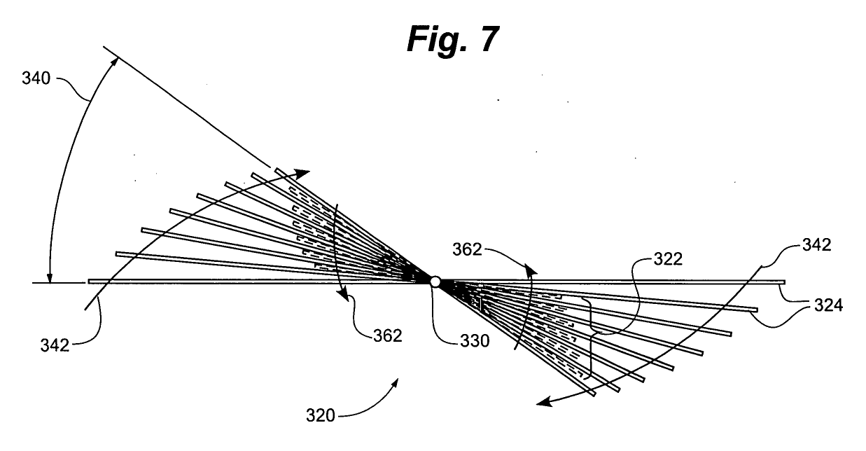

FIG. 7 shows an alternate embodiment of the invention in which there is overlap between inner and outer members of the device. Device 320 in FIG. 7 has inner members 322 which are angularly displaced from each other to span an arc that falls within a similar arc spanned by the angular displacement 340 of the outer members 324. The direction of bending of the outer members 324 of device 320 is shown to be clockwise (342) in the embodiment of FIG. 7, while the direction of bending of the inner members 322 of device 320 is shown to be counter-clockwise (362). In certain embodiments, the direction of bending of the inner and outer members may be in the same direction (i.e., both clockwise, or both counter-clockwise). In some embodiments of the invention, there may be more than two series of annular members, and some may bend in a clockwise direction, while others bend in a counter-clockwise direction, or all series of annular members may bend in the same direction, according to various embodiments of the invention.

In certain embodiments, the rotation of the inner and outer annular members (i.e., in response to rotation of the device) may create outer and inner moving image patterns. For example, an embodiment may create outer and inner annular images that appear to collapse toward each other when the device rotates about the vertical axis in a first direction. In a preferred embodiment, the device may also create outer and inner annular images that may appear to diverge away from each other when the device is rotated about the vertical axis in a second direction opposite the first direction.

Thus, embodiments of a DEVICE FOR PROVIDING MOVING VISUAL EFFECTS are disclosed. One skilled in the art will appreciate that the invention can be practiced with embodiments other than those disclosed. The disclosed embodiments are presented for purposes of illustration and not limitation, and the invention is limited only by the claims that follow.

What is claimed is:

1. An ornamental device comprising:
a plurality of generally annular members, including inner annular members and outer annular members, each member having a substantially planar surface, the substantially planar surfaces of the plurality of members adapted to intersect substantially along an axis of rotation of the device,
wherein an inner visual image and an outer visual image are formed by the inner and outer annular members upon rotation of the device about the axis of rotation.

2. The device of claim 1 wherein the inner and outer visual images move in different directions.

3. An ornamental device comprising:
a substantially vertical axis;
a plurality of generally concentric rings comprising
a first group of progressively sized rings, and
a second group of progressively sized rings, the first group of rings having radii generally greater than that of the second group of rings,
wherein the plurality of rings are angularly offset from one another to define a plurality of substantially vertical planes that intersect one another substantially along the vertical axis of the device,
wherein the device is adapted to rotate about the vertical axis, and
wherein multiple moving visual effects are formed by the first and second groups of rings upon rotation of the device about the vertical axis.

4. The device of claim 3 wherein the first group of rings are angularly offset from each other in a first direction of bending from a largest ring of the first group toward progressively smaller rings of the first group,
and wherein the second group of rings are angularly offset from each other in a second direction of bending from a largest ring of the second group toward progressively smaller rings of the second group, the second direction being opposite the first direction.

5. The device of claim 4 wherein at least one of the first direction and second direction is clockwise about the substantially vertical axis.

6. The device of claim 4 wherein at least one ring has a substantially planar surface.

7. The device of claim 6 wherein at least one substantially planar surface has been adapted to reflect light by a finishing process applied in a direction generally perpendicular to the vertical axis.

8. The device of claim 6 wherein at least one substantially planar surface further comprises a reflective coating.

9. The device of claim 4 wherein the angular offset between adjacent rings of a group is between about 2 degrees and about 30 degrees.

10. The device of claim 9 wherein the angular offset between adjacent rings of a group is between about 2 degrees and about 12 degrees.

11. The device of claim 9 wherein the angular offset between adjacent rings of a group is between about 5 degrees and about 30 degrees.

12. The device of claim 9 wherein the angular offset between adjacent rings of a group is approximately the same throughout the group.

13. The device of claim 4 wherein the angular displacement from a largest to a smallest ring of a group is between about 25 degrees and about 120 degrees.

14. The device of claim 13 wherein the angular displacement from a largest to a smallest ring of a group is between about 25 degrees and about 60 degrees.

15. The device of claim 13 wherein the angular displacement from a largest to a smallest ring of a group is between about 60 degrees and about 120 degrees.

16. The device of claim 4 wherein the number of rings in a group is within the range 3 to 20.

17. The device of claim 3 further comprising an ornamental figure disposed near the center of the device.

18. The device of claim 4 further comprising suspension means disposed near a top portion of the device for rotatably suspending the device.

19. The device of claim 18 wherein the suspension means comprises a hole formed in one of the plurality of rings.

20. An ornamental device comprising:
a substantially vertical axis;
a plurality of generally concentric rings comprising
a first group of rings having a scalloped outline,
at least one ring having a smooth outline, and
a second group of rings having a scalloped outline, the first group of rings having radii greater than that of the at least one smooth ring, the second group of rings having radii smaller than that of the at least one smooth ring,
wherein the plurality of generally concentric rings defines a plurality of substantially vertical planes that intersect one another substantially along the vertical axis of the device, the planes being angularly offset from one another to thereby give the device a three-dimensional shape,
wherein the device is adapted to rotate about the vertical axis, and
wherein multiple moving visual effects are formed by the first and second groups of scalloped rings upon rotation of the device about the vertical axis.

21. The device of claim 20 wherein the first group of rings are angularly offset from each other such that a direction of bending toward progressively smaller rings in the first group is in a first direction,
and wherein a direction of bending toward progressively smaller rings in the second group is in a second direction, the second direction being opposite the first direction.

22. A method of making an ornamental device that produces multiple, moving visual effects, the method comprising:
cutting a generally flat sheet of material into a shape;
making a plurality of cuts in the material, the cuts extending an arc of less than about 180 degrees on either side of a vertical axis of the device, the cuts made in pairs on opposite sides of the vertical axis and generally following the shape of the device to form a plurality of generally annular members; and
bending the generally annular members in a direction generally orthogonal to the vertical axis.

23. The method of claim 22 wherein the plurality of generally annular members formed includes a first and second group of annular members,
and wherein the step of bending the annular members further comprises bending the first group such that a direction of bending toward progressively smaller members in the first group is in a first direction,
and wherein a direction of bending toward progressively smaller members in the second group is in a second direction, the second direction being opposite the first direction.

24. The method of claim 23 further comprising applying a finishing process to at least one substantially planar surface in a direction generally perpendicular to the vertical axis.

25. The method of claim 23 further comprising applying a reflective coating to at least one substantially planar surface.
